(19) United States
(12) Patent Application Publication
(10) Pub. No.: US 2006/0180755 A1
(43) Pub. Date: Aug. 17, 2006

(54) Patterned nanostructure sample supports for mass spectrometry and methods of forming thereof

(76) Inventors: Ying-Lan Chang, Cupertino, CA (US); Dan-Hui Yang, Sunnyvale, CA (US); ChaoKun Lin, Fremont, CA (US); Jean L. Truche, Los Altos, CA (US); Jian Bai, Sunnyvale, CA (US)

Correspondence Address: AGILENT TECHNOLOGIES, INC.;INTELLECTUAL PROPERTY ADMINISTRATION, LEGAL DEPT., M/S DU404, P.O. BOX 7599, LOVELAND, CO, 80537-0599, US

(21) Appl. No.: 11/059,609

(22) Filed: Feb. 15, 2005

(51) Int. Cl. H01J 49/16

(52) U.S. Cl. 250/288

(57) ABSTRACT

A sample support for a mass spectrometry system is described. The sample support comprises a substrate and a set of carbon nanotube regions adjacent to the substrate and configured to promote ionization of a sample on the sample support.

### TECHNICAL FIELD

The technical field of the invention relates to analytical instruments and, in particular, to mass spectrometry.

### BACKGROUND

A variety of analytical instruments can be used for analyzing analytes such as biomolecules. More recently, mass spectrometry has gained prominence because of its ability to handle a wide variety of analytes with high sensitivity and rapid throughput. A variety of ion sources have been developed for use in mass spectrometry. Many of these ion sources comprise some type of mechanism that produces ions in accordance with an ionization process. One particular type of ionization process that is used is Matrix Assisted Laser Desorption Ionization (“MALDI”). One benefit of MALDI is its ability to produce ions from a wide variety of biomolecules such as proteins, peptides, oligosaccharides, and oligonucleotides. Another benefit of MALDI is its ability to produce ions with reduced fragmentation, thus facilitating identification of analytes from which the ions are produced.

Typically, MALDI produces ions from a co-precipitate of an analyte and a matrix. The matrix can comprise organic molecules that exhibit a strong absorption of light at a particular wavelength or a particular range of wavelengths, such as in the ultraviolet range. Examples of the matrix comprise 2,5-dihydroxybenzoic acid, 3,5-dimethoxy-4-hydroxycinnamic acid, α-cyano-4-hydroxycinnamic acid, and the like. For a conventional MALDI mass spectrometry system, an analyte and a matrix are dissolved in a solvent to form a solution, and the solution is then applied to or positioned on a sample support. As the solvent evaporates, the analyte and the matrix co-crystallize or co-precipitate on the sample support. The resulting co-precipitate is then irradiated with a short laser pulse, which induces an accumulation of energy in the co-precipitate through electronic excitation or molecular vibration of the matrix. As the matrix dissipates the energy by desorption, the matrix carries the analyte into a gaseous phase. During this desorption process, ions are produced from the analyte by charge transfer between the matrix and the analyte.

During operation of a conventional MALDI mass spectrometry system, characteristics of a sample support can affect distribution of a solution that is applied to the sample support, which can affect crystallization of an analyte on the sample support. In turn, adequate crystallization of the analyte can affect ionization efficiency for the analyte and, thus, sensitivity of mass spectrometric analyses. Accordingly, it is desirable to control distribution of a solution that is applied to a sample support, such that mass spectrometric analyses have a desired level of sensitivity.

### SUMMARY

The invention provides a mass spectrometry system. The mass spectrometry system comprises an ion source configured to produce ions from a sample. The ion source comprises a light source and a sample support adjacent to the light source and configured to support the sample. The sample support comprises a patterned nanostructure material. The mass spectrometry system also comprises a detector positioned with respect to the ion source to detect the ions.

The invention also provides an ion source for a mass spectrometry system. The ion source comprises a light source configured to produce light. The ion source also comprises a sample support adjacent to the light source and comprising a set of regions that are spaced apart from one another and comprise a nanostructure material.

The invention also provides a sample support for a mass spectrometry system. The sample support comprises a substrate and a set of carbon nanotube regions adjacent to the substrate and configured to promote ionization of a sample on the sample support.

The invention further provides a method of forming a sample support. The method comprises providing a substrate. The method also comprises forming a patterned layer adjacent to the substrate, and the patterned layer comprises a nanostructure material.

Advantageously, embodiments of the invention provide enhanced ionization efficiency, such that mass spectrometric analyses have a desired level of sensitivity. For some embodiments of the invention, enhanced ionization efficiency can be achieved by using certain nanostructure materials that control distribution of a sample on a sample support.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a mass spectrometry system implemented in accordance with an embodiment of the invention.

FIG. 2 illustrates a sample support implemented in accordance with an embodiment of the invention.

FIG. 3 illustrates a sample support implemented in accordance with another embodiment of the invention.

FIG. 4 illustrates a sample support implemented in accordance with a further embodiment of the invention.

### DETAILED DESCRIPTION

Definitions

The following definitions apply to some of the elements described with respect to some embodiments of the invention. These definitions may likewise be expanded upon herein.

As used herein, the singular terms “a,” “an,” and “the” comprise plural referents unless the context clearly dictates otherwise. Thus, for example, reference to a sample support can comprise multiple sample supports unless the context clearly dictates otherwise.

As used herein, the term “set” refers to a collection of one or more elements. Thus, for example, a set of nanostructures can comprise a single nanostructure or multiple nanostructures. Elements of a set can also be referred to as members of the set. Elements of a set can be the same or different. In some instances, elements of a set can share one or more common characteristics.

As used herein, the term “adjacent” refers to being near or adjoining. Adjacent structures can be spaced apart from one another or can be in actual contact with one another. In some instances, adjacent structures can be coupled to one another or can be formed integrally with one another.

As used herein, the term “ionization efficiency” refers to a ratio of the number of ions produced in an ionization process and the number of electrons or photons used in the ionization process.

As used herein, the term “ultraviolet range” refers to a range of wavelengths from about 5 nanometer (“nm”) to about 400 nm.

As used herein, the term “infrared range” refers to a range of wavelengths from about 750 nm to about 1 millimeter (“mm”).

As used herein, the term “nanometer range” or “nm range” refers to a range of sizes from about 0.1 nm to about 1,000 nm, such as from about 0.1 nm to about 500 nm, from about 0.1 nm to about 100 nm, from about 0.1 nm to about 50 nm, or from about 0.1 nm to about 10 nm.

As used herein, the term “micrometer range” or “μm range” refers to a range of sizes from about 0.1 micrometer (“μm”) to about 1,000 μm, such as from about 0.1 μm to about 500 μm, from about 0.1 μm to about 100 μm, from about 0.1 μm to about 50 μm, or from about 0.1 μm to about 10 μm.

As used herein, the term “aspect ratio” refers to a ratio of a largest dimension of a structure and an average of remaining dimensions of the structure, which remaining dimensions are orthogonal with respect to one another and with respect to the largest dimension. In some instances, remaining dimensions of a structure can be substantially the same, and an average of the remaining dimensions can substantially correspond to either of the remaining dimensions. For example, an aspect ratio of a cylinder refers to a ratio of a length of the cylinder and a cross-sectional diameter of the cylinder. As another example, an aspect ratio of a spheroid refers to a ratio of a major axis of the spheroid and a minor axis of the spheroid.

As used herein, the terms “reflective,” “reflecting,” “reflect,” and “reflection” refer to a bending or a deflection of light. A bending or a deflection of light can be substantially in a single direction, such as in the case of specular reflection, or can be in multiple directions, such as in the case of diffuse reflection or scattering. Reflective materials typically correspond to those materials that produce reflected light when those materials are irradiated with incident light. The reflected light and the incident light can comprise wavelengths that are the same or different.

As used herein, the terms “photoluminescent,” “photoluminesce,” and “photoluminescence” refer to an emission of light in response to energy excitation. Photoluminescent materials typically correspond to those materials that produce emitted light when those materials are irradiated with incident light. The emitted light and the incident light can comprise wavelengths that are the same or different.

As used herein, the terms “hydrophilic” and “hydrophilicity” refer to an affinity for water, while the terms “hydrophobic” and “hydrophobicity” refer to a lack of affinity for water. Hydrophobic materials typically correspond to those materials to which water has little or no tendency to adhere. As such, water on a surface of a hydrophobic material tends to bead up. Hydrophobic materials can sometimes be referred to as non-wetting materials. One measure of hydrophobicity of a material is a contact angle between a surface of the material and a line tangent to a drop of water at a point of contact with the surface. Typically, the material is considered to be hydrophobic if the contact angle is greater than about 90°, such as greater than about 100°, greater than about 105°, or greater than about 110°.

As used herein, the terms “inert” and “inertness” refer to a lack of interaction. Inert materials typically correspond to those materials that exhibit little or no tendency to interact with a sample under typical operating conditions, such as typical operating conditions of the sample supports described herein. Typically, inert materials also exhibit little or no tendency to interact with ions produced from a sample in accordance with an ionization process. While a material is sometimes referred to herein as being inert, it is contemplated that the material can exhibit some detectable tendency to interact with a sample under certain conditions. One measure of inertness of a material is its chemical reactivity. Typically, the material is considered to be inert if it exhibits little or no chemical reactivity with respect to a sample.

As used herein, the terms “robust” and “robustness” refer to a mechanical hardness or strength. Robust materials typically correspond to those materials that exhibit little or no tendency to fragment under typical operating conditions, such as typical operating conditions of the sample supports described herein. One measure of robustness of a material is its Vicker microhardness expressed in kilogram/millimeter (“kg/mm”). Typically, the material is considered to be robust if its Vicker microhardness is greater than about 1,000 kg/mm.

As used herein, the term “nanostructure” refers to a structure that comprises at least one dimension in the nm range. A nanostructure can comprise any of a wide variety of shapes and can be formed from any of a wide variety of materials. Examples of nanostructures comprise nanowires, nanotubes, nanoparticles, and the like.

As used herein, the term “nanowire” refers to an elongated nanostructure. Typically, a nanowire is substantially solid and, thus, can exhibit characteristics that differ from those of certain elongated, hollow nanostructures. In some instances, a nanowire can be represented as comprising a filled cylindrical shape. Typically, a nanowire comprises a cross-sectional diameter in the mn range, a length in the μm range, and an aspect ratio that is about 2 or greater. Examples of nanowires comprise those formed from semiconductor materials, such as silicon, gallium nitride, zinc oxide, and the like. A nanowire typically comprises a substantially ordered array or arrangement of atoms and, thus, can be referred to as being substantially ordered. It is contemplated that a nanowire can comprise a range of defects and can be doped or surface functionalized. It is also contemplated that a nanowire can comprise a set of heterojunctions or can comprise a core/sheath configuration. For example, a nanowire can comprise a core formed from zinc oxide and a sheath surrounding the core and formed from gallium nitride. Nanowires can be formed using any of a wide variety of techniques, such as arc-discharge, laser ablation, chemical vapor deposition, and the like.

As used herein, the term “nanotube” refers to an elongated, hollow nanostructure. In some instances, a nanotube can be represented as comprising an unfilled cylindrical shape. Typically, a nanotube comprises a cross-sectional diameter in the nm range, a length in the μm range, and an aspect ratio that is about 2 or greater. Examples of nanotubes comprise those formed from semiconductor materials, such as carbon, silicon, gallium nitride, and the like. A nanotube formed from carbon, namely a carbon nanotube, can be formed as a Single-Walled Carbon Nanotube (“SWCNT”) or a Multi-Walled Carbon Nanotube (“MWCNT”). A SWCNT can be represented as a single graphite layer that is rolled into a cylindrical shape. A SWCNT typically comprises a cross-sectional diameter that is less than about 2 nm, such as from about 0.1 nm to about 2 nm. A MWCNT can be represented as multiple graphite layers that are rolled into concentric cylindrical shapes. A MWCNT typically comprises a cross-sectional diameter that is about 2 nm or greater, such as from about 2 nm to about 100 nm. A nanotube typically comprises a substantially ordered array or arrangement of atoms and, thus, can be referred to as being substantially ordered. It is contemplated that a nanotube can comprise a range of defects and can be doped or surface functionalized. Nanotubes can be formed using any of a wide variety of techniques, such as arc-discharge, laser ablation, chemical vapor deposition, and the like. Nanotubes can also be formed from nanowires. For example, a nanowire can comprise a core/sheath configuration, and a core of the nanowire can be at least partly removed using any of a wide variety of techniques, such as preferential etching with xenon fluoride.

As used herein, the term “nanoparticle” refers to a spheroidal nanostructure. Typically, a nanoparticle comprises dimensions in the nm range and an aspect ratio that is less than about 2. Thus, for example, a nanoparticle can comprise a major axis and a minor axis that are both in the nm range. Examples of nanoparticles comprise those formed from semiconductor materials, such as carbon, zinc selenide, zinc sulfide, and the like. A nanoparticle typically comprises a substantially ordered array or arrangement of atoms and, thus, can be referred to as being substantially ordered. It is contemplated that a nanoparticle can comprise a range of defects and can be doped or surface functionalized. It is also contemplated that a nanoparticle can comprise a set of heterojunctions or can comprise a core/sheath configuration. For example, a nanoparticle can comprise a core formed from zinc selenide and a sheath surrounding the core and formed from zinc sulfide. Nanoparticles can be formed using any of a wide variety of techniques, such as aqueous synthetic routes and the like.

As used herein, the term “nanostructure material” refers to a material that comprises or is formed from a set of nanostructures. One example of a nanostructure material is one that comprises or is formed from a set of nanowires, namely a nanowire material. Another example of a nanostructure material is one that comprises or is formed from a set of nanotubes, namely a nanotube material. One example of a nanotube material is one that comprises or is formed from a set of carbon nanotubes, namely a carbon nanotube material. A further example of a nanostructure material is one that comprises or is formed from a set of nanoparticles, namely a nanoparticle material. In some instances, a nanostructure material can comprise a substantially random array or arrangement of nanostructures and, thus, can be referred to as being substantially random. In other instances, a nanostructure material can comprise a substantially ordered array or arrangement of nanostructures and, thus, can be referred to as being substantially ordered. For example, a nanostructure material can comprise an array of nanostructures that are substantially aligned with respect to one another or with respect to a certain axis, direction, plane, surface, or three-dimensional shape.

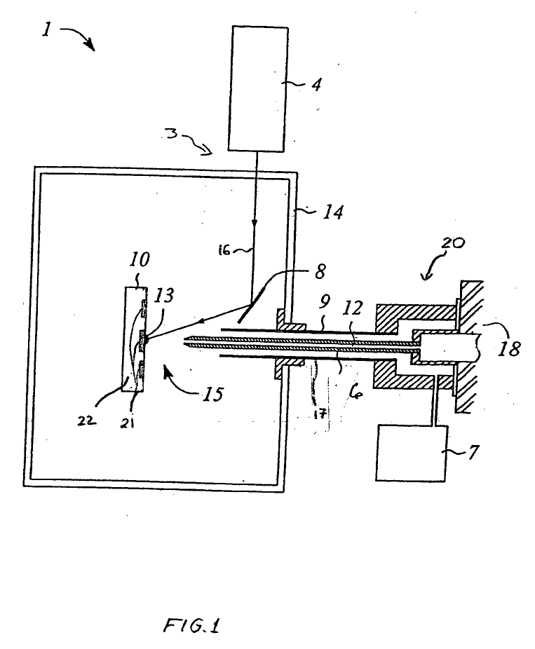

Attention first turns to FIG. 1, which illustrates a mass spectrometry system 1 implemented in accordance with an embodiment of the invention. The mass spectrometry system 1 comprises an ion source 3, which operates to produce ions. In the illustrated embodiment, the ion source 3 produces ions using MALDI. However, it is contemplated that the ion source 3 can be implemented to produce ions using any other ionization process, such as Atmospheric Pressure-Matrix Assisted Laser Desorption Ionization (“AP-MALDI”), Atmospheric Pressure Photo Ionization (“APPI”), and the like. It is also contemplated that the ion source 3 can be implemented as a multi-mode ion source that produces ions using a combination of ionization processes. As illustrated in FIG. 1, the mass spectrometry system 1 also comprises an ion transport system 20, which is positioned downstream with respect to the ion source 3 to transport ions. The mass spectrometry system 1 further comprises a detector 18, which is positioned downstream with respect to the ion transport system 20 to receive ions. The detector 18 operates to detect ions as a function of mass and charge.

As illustrated in FIG. 1, the ion source 3 comprises a light source 4, which operates to produce incident light 16. In the illustrated embodiment, the light source 4 is implemented as a laser that produces the incident light 16 in the form of a laser beam. Typically, the laser beam is pulsed and comprises a wavelength or a range of wavelengths in the ultraviolet range. However, it is contemplated that the laser beam need not be pulsed and can comprise any other wavelength or range of wavelengths, such as in the infrared range. In the illustrated embodiment, the ion source 3 also comprises a housing 14 that defines an ionization region 15 within which ions are produced. For certain implementations, the ionization region 15 can be maintained at a low pressure, such as under high vacuum conditions. As illustrated in FIG. 1, the ion source 3 further comprises a sample support 10, which is positioned within the ionization region 15 and is optically coupled to the light source 4 via an optional reflector 8. The sample support 10 operates to support or hold a sample 13, which comprises an analyte to be analyzed by the mass spectrometry system 1. For example, the sample 13 can comprise a co-precipitate of the analyte and a matrix, and the matrix can comprise organic molecules that exhibit a strong absorption of the incident light 16. However, it is contemplated that the sample 13 can comprise the analyte without requiring the matrix. During operation, the light source 4 produces the incident light 16, which is directed into the ionization region 15 and reaches the sample support 10 via the reflector 8. The incident light 16 interacts with the sample 13 to produce ions from the analyte. The ions are released into the ionization region 15 and eventually reach the ion transport system 20.

Referring to FIG. 1, the ion transport system 20 comprises a mass analyzer 17, which operates to separate or select ions by mass-to-charge ratio. In the illustrated embodiment, the mass analyzer 17 is implemented as a time-of-flight analyzer. However, it is contemplated that other types of mass analyzers can be used, such as ion trap devices, quadrupole mass spectrometers, magnetic sector spectrometers, and the like. As illustrated in FIG. 1, the mass analyzer 17 comprises a capillary 6, which defines an internal passageway 12. During operation, ions are produced by the ion source 3, and the ions pass through the capillary 6 via the internal passageway 12. As illustrated in FIG. 1, the ion transport system 20 also comprises a gas source 7 and a gas conduit 9 that encloses the capillary 6. The gas conduit 9 is fluidly coupled to the gas source 7 and operates to supply an inert gas to the ionization region 15. Referring to FIG. 1, the detector 18 is positioned downstream with respect to the mass analyzer 17 to receive ions. During operation, ions pass through the capillary 6 and eventually reach the detector 18, which operates to detect the abundance of the ions and to produce a mass spectrum.

Characteristics of the sample support 10 can affect distribution of the sample 13 (in its liquid form) on the sample support 10, which can affect crystallization of the analyte on the sample support 10. In turn, adequate crystallization of the analyte can affect ionization efficiency for the analyte and, thus, sensitivity of mass spectrometric analyses. Accordingly, it is desirable to control distribution of the sample 13 on the sample support 10, such that mass spectrometric analyses have a desired level of sensitivity.

As illustrated in FIG. 1, the sample support 10 comprises a substrate 22 and a nanostructure material 21, such as a carbon nanotube material. In the illustrated embodiment, the nanostructure material 21 is formed as a patterned layer or coating that is adjacent to the substrate 22. It is also contemplated that the sample support 10 can be substantially formed from the nanostructure material 21. Advantageously, the nanostructure material 21 can control distribution of the sample 13 on the sample support 10, such that mass spectrometric analyses have a desired level of sensitivity. In particular, the nanostructure material 21 can be highly hydrophobic and, thus, can serve to restrain the sample 13 (in its liquid form) from spreading along the sample support 10. It is also contemplated that the nanostructure material 21 can be initially hydrophilic, and hydrophobicity of the nanostructure material 21 can be achieved by, for example, surface functionalization. Without wishing to be bound by a particular theory, it is believed that patterning of the nanostructure material 21 can promote formation of well-defined crystals or co-precipitates of the sample 13 on the sample support 10. In such manner, the nanostructure material 21 can serve to concentrate the sample 13 at one or more desired locations on the sample support 10, thus enhancing absorption of light by the sample 13.

In conjunction with the characteristics discussed above, the nanostructure material 21 can exhibit a number of other characteristics that are desirable for mass spectrometry. For example, another benefit of the nanostructure material 21 is that it can enhance absorption of light by the sample 13 by transferring energy associated with the incident light 16 to the sample 13. In such manner, the nanostructure material 21 can enhance ionization efficiency for the analyte and, thus, can provide an enhanced level of sensitivity for mass spectrometric analyses. It is contemplated that the nanostructure material 21 can serve as a matrix to promote ionization of the analyte, such that the sample 13 need not comprise a separate matrix in the form of organic molecules. In such manner, the nanostructure material 21 can further enhance the level of sensitivity by reducing undesirable chemical background noise that can be produced from those organic molecules.

For example, the nanostructure material 21 can be reflective and can enhance absorption of light by the sample 13 by reflecting the incident light 16 back towards the sample 13. During operation, a portion of the incident light 16 that is not initially absorbed by the sample 13 passes through the sample 13 and eventually reaches the nanostructure material 21. In turn, the nanostructure material 21 can reflect this portion of the incident light 16 back towards the sample 13. In such manner, the nanostructure material 21 can provide multi-path irradiation of the sample 13 to enhance a capture cross-section of the incident light 16, thus promoting production of ions from the analyte. Alternatively, or in conjunction, the nanostructure material 21 can enhance absorption of light by the sample 13 by exhibiting photoluminescence in response to the incident light 16. During operation, a portion of the incident light 16 that is not initially absorbed by the sample 13 passes through the sample 13 and eventually reaches the nanostructure material 21. In turn, the nanostructure material 21 can produce emitted light in response to this portion of the incident light 16. In such manner, the nanostructure material 21 can irradiate the sample 13 with the emitted light, thus promoting production of ions from the analyte. In some instances, the emitted light comprises a wavelength or a range of wavelengths in the ultraviolet range. However, it is contemplated that the emitted light can comprise any other wavelength or range of wavelengths.

Another benefit of the nanostructure material 21 is that it can be highly inert with respect to typical analytes for mass spectrometry. Accordingly, use of the nanostructure material 21 can reduce undesirable interaction with an analyte for a current test as well as reduce contamination of the sample support 10 with a residual analyte from a previous test. A further benefit of the nanostructure material 21 is that it can be highly robust when implemented in the sample support 10. Thus, the nanostructure material 21 can exhibit little or no tendency to degrade under typical operating conditions of the sample support 10, thus reducing undesirable chemical background noise in a mass spectrum. Robustness of the nanostructure material 21 can also allow the sample support 10 to be readily cleaned and to be reused for multiple tests.

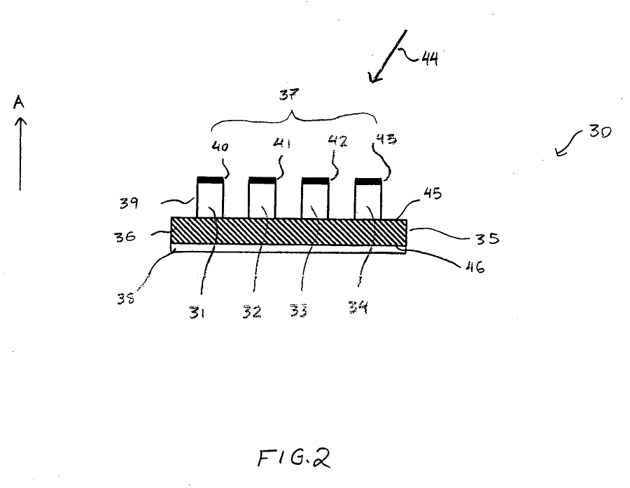

Attention next turns to FIG. 2, which illustrates a sample support 30 implemented in accordance with an embodiment of the invention. The sample support 30 comprises a substrate 35, which comprises a first layer 36 and a second layer 39 that is adjacent to the first layer 36. In the illustrated embodiment, the first layer 36 comprises silicon, and the second layer 39 comprises silicon dioxide, which can be hydroxylated for certain implementations. As illustrated in FIG. 2, the second layer 39 comprises a set of pillars, namely pillars 31, 32, 33, and 34, which extend from a surface 45 of the first layer 36 and operate to support a sample (not illustrated). While four pillars 31, 32, 33, and 34 are illustrated in FIG. 2, it is contemplated that more or less pillars can be formed for other implementations. The pillars 31, 32, 33, and 34 are substantially aligned with respect to a common direction (illustrated as arrow A) and are substantially regularly spaced with respect to one another along the surface 45. In the illustrated embodiment, the common direction is substantially orthogonal with respect to the surface 45. In other words, an angle defined by the common direction and the surface 45 is substantially 90°. However, it is contemplated that this angle can be adjusted to differ from 90°, such as any other angle from 0° to 180°.

In the illustrated embodiment, the sample support 30 also comprises a carbon nanotube material 37 that is adjacent to the second layer 39. It is contemplated that other types of nanostructure materials can be used in place of, or in conjunction with, the carbon nanotube material 37. As illustrated in FIG. 2, the carbon nanotube material 37 is formed as a set of regions, namely regions 40, 41, 42, and 43, which are positioned on respective ones of the pillars 31, 32, 33, and 34. In accordance with the spacing of the pillars 31, 32, 33, and 34, the regions 40, 41, 42, and 43 are also substantially regularly spaced with respect to one another. While four regions 40, 41, 42, and 43 are illustrated in FIG. 2, it is contemplated that more or less regions can be formed for other implementations. In the illustrated embodiment, the sample support 30 further comprises a reflective coating 38, which is adjacent to a surface 46 of the first layer 36. The reflective coating 38 can comprise a reflective material, such as aluminum.

Without wishing to be bound by a particular theory, it is believed that use of the multiple regions 40, 41, 42, and 43 that are spaced apart from one another can promote formation of well-defined crystals or co-precipitates on one or more of the regions 40, 41, 42, and 43. In such manner, the regions 40, 41, 42, and 43 can serve to enhance absorption of light by the sample by concentrating the sample on one or more of the regions 40, 41, 42, and 43. In addition, use of the multiple regions 40, 41, 42, and 43 can enhance throughput for mass spectrometric analyses by allowing multiple portions of the sample or multiple samples to be analyzed in a single test. In conjunction with the characteristics discussed above, the regions 40, 41, 42, and 43 can exhibit a number of other characteristics that are desirable for mass spectrometry. In particular, as incident light 44 is directed towards the sample support 30, the regions 40, 41, 42, and 43 can promote ionization of a sample by reflecting the incident light 44 back towards the sample. In the illustrated embodiment, the reflective coating 38 can also promote ionization of the sample by performing a similar reflective function. Alternatively, or in conjunction, the regions 40, 41, 42, and 43 can promote ionization of the sample by exhibiting photoluminescence in response to the incident light 44. It is contemplated that the alignment, spacing, and dimensions of the pillars 31, 32, 33, and 34 and the regions 40, 41, 42, and 43 can be adjusted to tune various desirable characteristics to particular levels.

The sample support 30 can be formed using any of a wide variety of techniques. In particular, the second layer 39 can be patterned using, for example, photolithography and etching to form the pillars 31, 32, 33, and 34. In some instances, a metal can be used in place of, or in conjunction with, a photoresist for patterning the second layer 39. Advantageously, patterning of the second layer 39 can provide a template that allows the carbon nanotube material 37 to be substantially selectively deposited or grown at desired locations of the substrate 35. For example, a set of carbon nanotubes can be dispersed in a suitable solvent to form a carbon nanotube suspension, and the carbon nanotube suspension can be applied to the substrate 35 to deposit carbon nanotubes on the pillars 31, 32, 33, and 34. The carbon nanotube suspension can be applied to the substrate 35 using any of a wide variety of techniques, such as spinning, spraying, dipping, painting, and the like. As a result of the greater hydrophilicity of silicon dioxide with respect to silicon, the carbon nanotube suspension can preferentially wet the pillars 31, 32, 33, and 34, which allows carbon nanotubes to be substantially selectively deposited on the pillars 31, 32, 33, and 34. By adjusting the concentration of carbon nanotubes in the suspension, the density of carbon nanotubes that are deposited on the pillars 31, 32, 33, and 34 can be controlled. In some instances, the carbon nanotube suspension can be sonicated to reduce undesirable aggregation of carbon nanotubes in the suspension. Once the carbon nanotube suspension is applied to the substrate 35, the substrate 35 can be dried while retaining the carbon nanotubes that are deposited on the pillars 31, 32, 33, and 34. Deposition of carbon nanotubes can be repeated one or more times to form multiple layers or to increase the density of carbon nanotubes that are deposited on the pillars 31, 32, 33, and 34. Without wishing to be bound by a particular theory, it is believed that carbon nanotubes that are deposited on the pillars 31, 32, 33, and 34 can promote selective deposition of additional carbon nanotubes through Van der Waals or similar type interactions.

Alternatively, or in conjunction, carbon nanotubes can be grown on the pillars 31, 32, 33, and 34 using, for example, chemical vapor deposition. Growth of carbon nanotubes can depend on positioning of catalysts used for chemical vapor deposition. In some instances, catalysts can be substantially selectively deposited on the pillars 31, 32, 33, and 34 using a suitable catalyst suspension, such as an aqueous solution of FeCl₃, hydroxylamine, and catalyst particles. Without wishing to be bound by a particular theory, it is believed that hydroxyls groups of hydroxylated silicon dioxide can promote selective deposition of the catalyst particles through a surface-mediated process. The reflective coating 38 can be applied to the substrate 35 using any of a wide variety of techniques, such as spinning, spraying, dipping, painting, and the like.

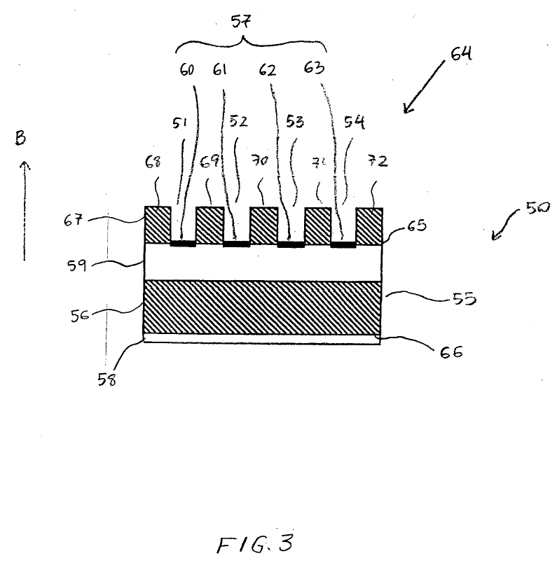

Attention next turns to FIG. 3, which illustrates a sample support 50 implemented in accordance with another embodiment of the invention. The sample support 50 comprises a substrate 55, which comprises a first layer 56, a second layer 59 that is adjacent to the first layer 56, and a third layer 67 that is adjacent to the second layer 59. In the illustrated embodiment, the first layer 56 and the third layer 67 comprise silicon, and the second layer 59 comprises silicon dioxide, which can be hydroxylated for certain implementations. As illustrated in FIG. 3, the third layer 67 comprises a set of pillars, namely pillars 68, 69, 70, 71, and 72, which extend from a surface 65 of the second layer 59. While five pillars 68, 69, 70, 71, and 72 are illustrated in FIG. 3, it is contemplated that more or less pillars can be formed for other implementations. The pillars 68, 69, 70, 71, and 72 are substantially aligned with respect to a common direction (illustrated as arrow B) and are substantially regularly spaced with respect to one another along the surface 65. In the illustrated embodiment, the common direction is substantially orthogonal with respect to the surface 65. However, it is contemplated that this angle can be adjusted to differ from 90°, such as any other angle from 0° to 180°. As illustrated in FIG. 3, the pillars 68, 69, 70, 71, and 72 define a set of trenches, namely trenches 51, 52, 53, and 54, which operate to hold a sample (not illustrated). In accordance with the spacing of the pillars 68, 69, 70, 71, and 72, the trenches 51, 52, 53, and 54 are also substantially regularly spaced with respect to one another. While four trenches 51, 52, 53, and 54 are illustrated in FIG. 3, it is contemplated that more or less trenches can be formed for other implementations.

In the illustrated embodiment, the sample support 50 also comprises a carbon nanotube material 57 that is adjacent to the second layer 59. It is contemplated that other types of nanostructure materials can be used in place of, or in conjunction with, the carbon nanotube material 57. As illustrated in FIG. 3, the carbon nanotube material 57 is formed as a set of regions, namely regions 60, 61, 62, and 63, which are positioned in respective ones of the trenches 51, 52, 53, and 54. In accordance with the spacing of the trenches 51, 52, 53, and 54, the regions 60, 61, 62, and 63 are also substantially regularly spaced with respect to one another. While four regions 60, 61, 62, and 63 are illustrated in FIG. 3, it is contemplated that more or less regions can be formed for other implementations. In the illustrated embodiment, the sample support 50 further comprises a reflective coating 58, which is adjacent to a surface 66 of the first layer 56. The reflective coating 58 can comprise a reflective material, such as aluminum.

Without wishing to be bound by a particular theory, it is believed that use of the multiple regions 60, 61, 62, and 63 can promote formation of well-defined crystals or co-precipitates and can enhance throughput for mass spectrometric analyses. In conjunction with the characteristics discussed above, the regions 60, 61, 62, and 63 can exhibit a number of other characteristics that are-desirable for mass spectrometry. In particular, as incident light 64 is directed towards the sample support 50, the regions 60, 61, 62, and 63 can promote ionization of a sample by reflecting the incident light 64 back towards the sample. In the illustrated embodiment, the reflective coating 58 can also promote ionization of the sample by performing a similar reflective function. Alternatively, or in conjunction, the regions 60, 61, 62, and 63 can promote ionization of the sample by exhibiting photoluminescence in response to the incident light 64. It is contemplated that the alignment, spacing, and dimensions of the pillars 68, 69, 70, 71, and 72, the trenches 51, 52, 53, and 54, and the regions 60, 61, 62, and 63 can be adjusted to tune various desirable characteristics to particular levels.

The sample support 50 can be formed using any of a wide variety of techniques. In particular, the third layer 67 can be patterned using, for example, photolithography and etching to form the pillars 68, 69, 70, 71, and 72 and the trenches 51, 52, 53, and 54. In some instances, a metal can be used in place of, or in conjunction with, a photoresist for patterning the third layer 67. In a similar manner as discussed previously, patterning of the third layer 67 can provide a template that allows the carbon nanotube material 57 to be substantially selectively deposited or grown at desired locations of the substrate 55. The reflective coating 58 can be applied to the substrate 55 using any of a wide variety of techniques, such as spinning, spraying, dipping, painting, and the like.

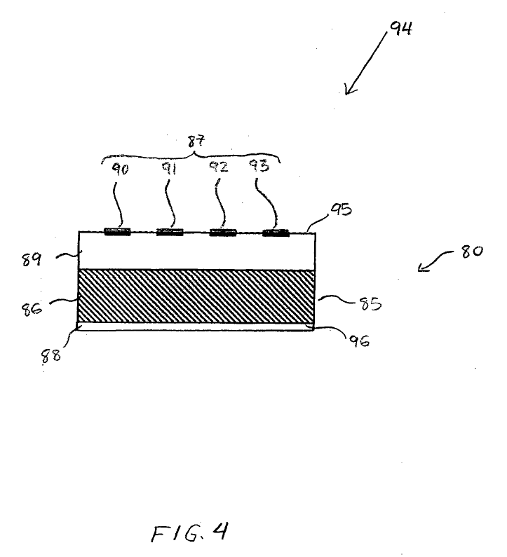

Attention next turns to FIG. 4, which illustrates a sample support 80 implemented in accordance with a further embodiment of the invention. The sample support 80 comprises a substrate 85, which comprises a first layer 86 and a second layer 89 that is adjacent to the first layer 86. In the illustrated embodiment, the first layer 86 comprises silicon, and the second layer 89 comprises silicon dioxide. As illustrated in FIG. 4, the sample support 80 also comprises a carbon nanotube material 87 that is adjacent to the second layer 89. It is contemplated that other types of nanostructure materials can be used in place of, or in conjunction with, the carbon nanotube material 87. The carbon nanotube material 87 is formed as a set of regions, namely regions 90, 91, 92, and 93, which are substantially regularly spaced with respect to one another along a surface 95 of the second layer 89. While four regions 90, 91, 92, and 93 are illustrated in FIG. 4, it is contemplated that more or less regions can be formed for other implementations. In the illustrated embodiment, the sample support 80 further comprises a reflective coating 88, which is adjacent to a surface 96 of the first layer 86. The reflective coating 88 can comprise a reflective material, such as aluminum.

Without wishing to be bound by a particular theory, it is believed that use of the multiple regions 90, 91, 92, and 93 can promote formation of well-defined crystals or co-precipitates and can enhance throughput for mass spectrometric analyses. In conjunction with the characteristics discussed above, the regions 90, 91, 92, and 93 can exhibit a number of other characteristics that are desirable for mass spectrometry. In particular, as incident light 94 is directed towards the sample support 80, the regions 90, 91, 92, and 93 can promote ionization of a sample by reflecting the incident light 94 back towards the sample. In the illustrated embodiment, the reflective coating 88 can also promote ionization of the sample by performing a similar reflective function. Alternatively, or in conjunction, the regions 90, 91, 92, and 93 can promote ionization of the sample by exhibiting photoluminescence in response to the incident light 94. It is contemplated that the spacing and dimensions of the regions 90, 91, 92, and 93 can be adjusted to tune various desirable characteristics to particular levels.

The sample support 80 can be formed using any of a wide variety of techniques. In particular, the carbon nanotube material 87 can be deposited or grown on the surface 95, and the carbon nanotube material 87 can be patterned using, for example, photolithography and etching to form the regions 90, 91, 92, and 93. For example, a photoresist layer can be formed so as to cover the carbon nanotube material 87, and the photoresist layer can be patterned to cover portions of the carbon nanotube material 87 that correspond to the regions 90, 91, 92, and 93. Next, remaining portions of the carbon nanotube material 87 can be removed using any of a wide variety of techniques, such as oxygen plasma etching, reactive ion etching, and the like. The patterned photoresist layer can then be removed while retaining the regions 90, 91, 92, and 93 on the substrate 85. The reflective coating 88 can be applied to the substrate 85 using any of a wide variety of techniques, such as spinning, spraying, dipping, painting, and the like.

A practitioner of ordinary skill in the art requires no additional explanation in developing the sample supports described herein but may nevertheless find some helpful guidance by examining the following references: Choi et al., “Efficient Formation of Iron Nanoparticle Catalyst on Silicon Oxide by Hydroxylamine for Carbon Nanotube Synthesis and Electronics,” NanoLetters, 3, 157-161, 2003; and Lustig et al., “Lithographically Cut Single-Walled Carbon Nanotubes: Controlling Length Distribution and Introducing End-Group Functionality,” NanoLetters, 3, 1007-1012, 2003; the disclosures of which are incorporated herein by reference in their entireties.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process operation or operations, to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

We claim:

1. A mass spectrometry system, comprising:
(a) an ion source configured to produce ions from a sample and comprising:
(i) a light source; and
(ii) a sample support adjacent to the light source and configured to support the sample, the sample support comprising a patterned nanostructure material; and
(b) a detector positioned with respect to the ion source to detect the ions.

2. The mass spectrometry system of claim 1, wherein the light source comprises a laser.

3. The mass spectrometry system of claim 1, wherein the patterned nanostructure material comprises a set of nanostructure regions that are spaced apart from one another.

4. The mass spectrometry system of claim 1, wherein the set of nanostructure regions comprise a carbon nanotube material that is hydrophobic.

5. The mass spectrometry system of claim 1, wherein the set of nanostructure regions comprise a carbon nanotube material that is reflective.

6. The mass spectrometry system of claim 1, wherein the set of nanostructure regions comprise a carbon nanotube material that is inert.

7. An ion source for a mass spectrometry system, comprising:
(a) a light source configured to produce light; and
(b) a sample support adjacent to the light source and comprising a plurality of regions that are spaced apart from one another and comprise a nanostructure material.

8. The ion source of claim 7, wherein the nanostructure material comprises a carbon nanotube material.

9. The ion source of claim 8, wherein the carbon nanotube material provides a hydrophobic surface.

10. The ion source of claim 9, wherein the hydrophobic surface exhibits a contact angle with respect to water that is greater than 100°.

11. The ion source of claim 8, wherein the carbon nanotube material is configured to ionize a sample on the sample support based on at least one of:
(i) reflecting the light from the light source towards the sample; and
(ii) exhibiting photoluminescence in response to the light from the light source.

12. The ion source of claim 7, wherein the nanostructure material is surface functionalized to provide a hydrophobic surface.

13. A sample support for a mass spectrometry system, comprising:
(a) a substrate; and
(b) a plurality of carbon nanotube regions adjacent to the substrate and configured to promote ionization of a sample on the sample support.

14. The sample support of claim 13, wherein the plurality of carbon nanotube regions are spaced apart from one another.

15. The sample support of claim 13, wherein the substrate comprises a plurality of pillars, and the plurality of carbon nanotube regions are positioned on respective ones of the plurality of pillars.

16. The sample support of claim 13, wherein the substrate comprises a plurality of trenches, and the plurality of carbon nanotube regions are positioned in respective ones of the plurality of trenches.

17. A method of forming a sample support, comprising:
(a) providing a substrate; and
(b) forming a patterned layer adjacent to the substrate, the patterned layer comprising a nanostructure material.

18. The method of claim 17, wherein the forming the patterned layer comprises:
(i) patterning the substrate to form a plurality of pillars; and
(ii) applying the nanostructure material to the patterned substrate to position the nanostructure material on the plurality of pillars.

19. The method of claim 17, wherein the forming the patterned layer comprises:
(i) patterning the substrate to form a plurality of trenches; and
(ii) applying the nanostructure material to the patterned substrate to position the nanostructure material in the plurality of trenches.

20. The method of claim 17, wherein the forming the patterned layer comprises:
(i) applying the nanostructure material to the substrate to position the nanostructure material adjacent to the substrate; and
(ii) patterning the nanostructure material.
